(19) United States
(12) Patent Application Publication
(10) Pub. No.: US 2006/0038774 A1
(43) Pub. Date: Feb. 23, 2006

(54) System and method for automatically establishing handedness settings of embedded input device

(76) Inventors: John Carl Mese, Cary, NC (US); Rod David Waltermann, Rougemont, NC (US); Arnold S. Weksler, Raleigh, NC (US)

Correspondence Address: ROGITZ & ASSOCIATES, 750 B STREET, SUITE 3120, SAN DIEGO, CA, 92101, US

(21) Appl. No.: 10/922,447

(22) Filed: Aug. 20, 2004

(51) Int. Cl. G09G 5/00

(52) U.S. Cl. 345/156

(57) ABSTRACT

Handedness settings for an embedded point and click input device are automatically established based on signals that are generated when a user rests his hand on the device. For example, the device can be a joystick or a button-like trackpoint element on the keyboard of an IBM Thinkpad®.

### FIELD OF THE INVENTION

The present invention relates generally to automatically establishing handedness settings of an embedded computer pointing and clicking input device.

### BACKGROUND

Computer pointing and input devices such as mice, joysticks, and touch pads with left and right entry buttons typically have more than a single element that can be manipulated to send signals to a host computer. Specifically, two input buttons, usually referred to as a left button and a right button owing to their orientation on the input device, are provided that a user can click to invoke respective functions.

In typical applications, the left button can be used in drag and drop operations and can be double clicked to open files, whereas the right button usually enables opening files with a single click. Of course, the buttons can have other functions as is known in the art.

Because most computer users are right-handed, it is generally the case that more frequent functions are assigned to the button which commonly is expected to rest under the index finger of a right-handed user. But left-handed users usually rest their index fingers over the opposite button, so most operating systems allow left-handed users to access a control panel and switch button functions in software, with typically left button functions switched to the right button and vice-versa. As understood herein, requiring a user to take affirmative steps to establish the “handedness” of a pointing device is inconvenient to the user.

IBM's U.S. Pat. No. 5,841,425 discloses a system for automatically sensing handedness and establishing button functions in response that uses a light sensing scheme. The present invention recognizes that this is effective, but that other inventive ways can also advantageously be used to sense handedness and establish button functions in response by, e.g., using pre-existing devices already present in the computer for undertaking functions other than establishing handedness.

### SUMMARY OF THE INVENTION

The invention may be implemented as one or more of a computer-executed method, a computer system, a computer program device, and a service. In one implementation a method includes receiving a signal from an input device on a computer. The input device is a legacy input device that has at least one function other than establishing handedness settings and that is embedded in the computer, e.g., that is mounted on a keyboard region of the computer. The signal is generated when a user makes resting tactile contact with the input device. Based on the signal, handedness settings are automatically established.

It is to be understood that while “handedness settings” refer below to the functions assigned to click elements, “handedness” or “handedness settings” more generally refer to functions that may be assigned to other types of input devices and/or to other aspects of computer systems.

In a non-limiting embodiment the input device includes a touch pad and two buttons, and the handedness settings are established for the buttons based on a signal that is generated when a user makes resting tactile contact with the touch pad. With more specificity, a touch region may be defined when the user makes resting tactile contact with the touch pad, and the signal represents a shape and/or a location and/or an orientation of the touch region, which can then be correlated to the left hand or right hand.

In another non-limiting embodiment the input device includes a pivotable pointing element mounted on a keyboard region of the computer and two buttons, and the handedness settings are established for the buttons based on a signal that is generated when a user makes resting tactile contact with the pointing element. With more specificity, the pointing element may be an axial motion detection device that can include a joystick or so-called trackpoint element that is associated with a pressure transducer, and resting tactile contact with the pointing element causes a current imbalance in the pressure transducer. The signal that is generated when a user makes resting tactile contact with the pointing element is representative of the current imbalance, and can be correlated to left handedness or right handedness.

As yet another alternative, the input device may include two buttons and a fingerprint reader, and the computer correlates a fingerprint image from the reader to a left finger or right finger to establish the handedness setting.

In another aspect, a computer includes a computer housing holding a processor, a pointing element, and at least two click elements. The processor automatically establishes functions for the click elements based solely on a signal from the pointing element.

In still another aspect, a computer includes a fingerprint reader. The computer correlates a fingerprint image from the reader to a left finger or right finger to establish at least one handedness setting for at least one input device.

In yet another aspect, a service includes receiving a fingerprint signal from a user computer and returning to the user computer a signal representing “left” or “right” to facilitate establishing handedness settings for click elements associated with the computer.

In another aspect, a computer program product is disclosed for use with a computer holding a processor, a means for pointing, and at least two means for clicking. The program product includes means for automatically establishing handedness settings based on a signal that is generated when a user makes resting tactile contact with the means for pointing.

In yet another aspect, a computer system has a processor supported by a computer housing and a wrist rest juxtaposed with the housing. Plural pressure sensors are disposed in the body for outputting signals representative of a user resting a portion of the user's body on the wrist rest. The signals are used by the processor in determining handedness settings for click elements on the computer body.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of the present architecture;

FIG. 2 is a block diagram of non-limiting pointing device electronics;

FIG. 3 is a flow chart showing the logic for automatically establishing handedness according to a first embodiment;

FIG. 4 is a flow chart showing the logic for automatically establishing handedness according to a second embodiment;

FIG. 5 is a flow chart showing the logic for automatically establishing handedness according to a third embodiment;

FIG. 6 is a block diagram of another architecture in which pressure sensors are disposed in a wrist rest; and

FIG. 7 is a flow chart showing the logic for automatically establishing handedness according to a the embodiment of FIG. 6.

### DETAILED DESCRIPTION OF THE PREFERRED EMBODIMENT

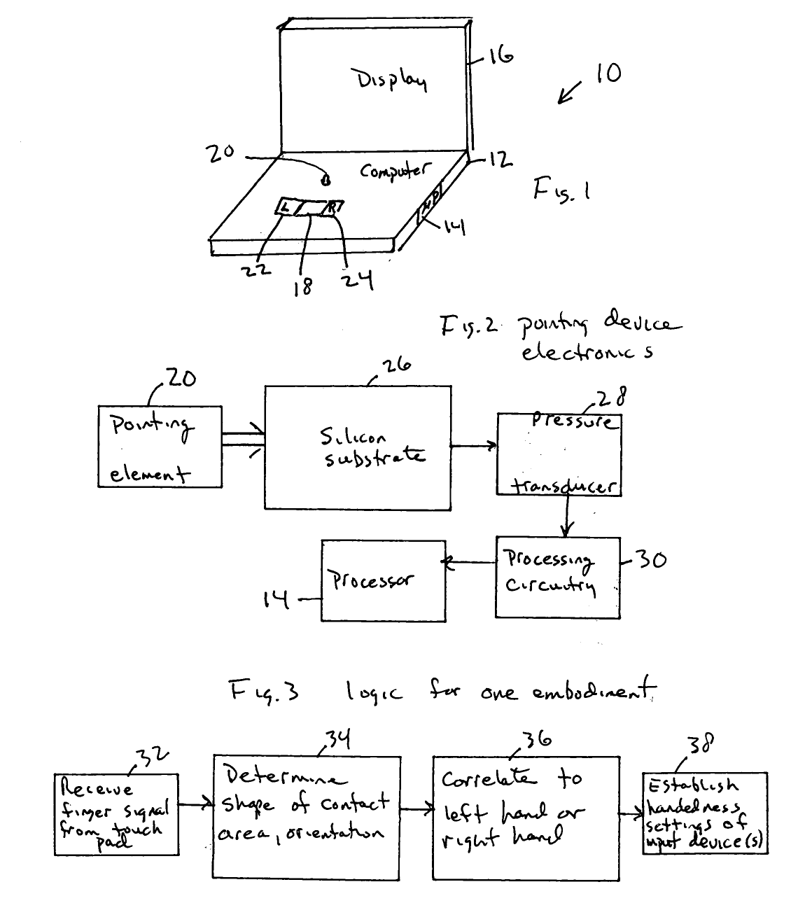

Referring initially to FIG. 1, a computing system is shown, generally designated 10, that includes a computer 12 having a processor 14 and a display 16. The computer 12 can be any suitable computer, e.g., a personal computer or larger (mainframe), a laptop computer, a notebook computer or smaller, etc. For instance, the computer 12 without limitation can be an IBM Thinkpad® or ThinkCentre™ computer. The processor 14 may access computer programs on program devices such as but not limited to floppy diskettes, hard disk drives, optical disks, and solid state memory to execute the logic herein.

In the non-limiting embodiment shown, the computer 12 may include one or more pointing devices, such as a non-movable touch pad 18 and a movable pointing element, such as a joystick or trackpoint-type element 20. Both of the pointing devices shown in FIG. 1 are “embedded” in that they are mounted on the keyboard region of the housing of the computer 12 as shown. The pointing devices 18, 20 can be manipulated in accordance with principles known in the art to cause a cursor to move across the display 16. Thus, the pointing devices 18, 20 are existing legacy devices that have functions other than establishing handedness settings.

Additionally, the non-limiting computer 12 shown in FIG. 1 includes at least two click elements 22, 24 (labelled “L” for left and “R” for right in FIG. 1). In the embodiment shown, the click elements 22, 24 are buttons that can be depressed, with each click element 22, 24 being associated with a respective function or set of functions that might overlap with those of the other click element but that typically are not identical to those of the other click element. A user can depress the click elements 22, 24 in accordance with principles known in the art to enter information to the processor 14 to cause the processor 14 to, e.g., open files, select entries under the cursor, etc.

As recognized herein, the functions undertaken by the click elements 22, 24 are not hard-wired into the elements, but rather are associated with the elements in software by the operating system of the computer 12. Accordingly, to change the functions of the click elements, i.e., to establish the “handedness settings” of the elements, software can be accessed to assign a first function or set of functions to the left click element 22 and to assign a second function or set of functions to the right click element 24, and to swap the first and second function or functions as desired by the user. It is the purpose of the present invention to automatically establish the handedness settings without requiring the user to access the operating system and manually change functions between buttons.

In the preferred embodiment, this is established by sensing “resting tactile contact” of the user's fingers against a pointing device of the computer. By “resting tactile contact” is meant the tactile contact that occurs when a user naturally rests a finger or fingers on a pointing device without meaning to input information (such as cursor moves) to the processor 14. As understood herein, a left-handed user typically will rest fingers on pointing devices differently than a right-handed user owing to the body's natural conformation and the at-rest orientation differences between left and right extremities.

To better understand portions of the logic set forth further below, FIG. 2 shows components that are associated with the movable pointing element 20 shown in FIG. 1. The pointing element 20 is mechanically coupled to a substrate 26 that may be made of silicon, and a pressure transducer 28 is coupled to the substrate 26. With more specificity and in accordance with principles known in the art, four resistors, one at each corner of the substrate, can be used in a bridge configuration, wherein current flow through the bridge is balanced when the pointing element is in a neutral position and unbalanced otherwise. The signal from the pressure transducer, which consequently represents the position of the pointing element and, hence, the desired direction of travel of the cursor, can be processed by circuitry 30 for use by the processor 14 in determining how to move the cursor.

As understood herein, when a user rests a finger on the pointing element 20, the current through the resistance bridge in the pressure transducer 28 is slightly unbalanced. The processor 14 may be programmed to essentially zero out or otherwise ignore signals of low amplitude on the assumption that such signals do not represent desired current motion but rather the relatively light force that results when a user absentmindedly rests a finger against the pointing element 20. As set forth further below in reference to FIG. 4, the signals that result from resting a finger against the pointing element 20 can also be used in accordance with present principles to establish handedness settings of the click elements 22, 24.

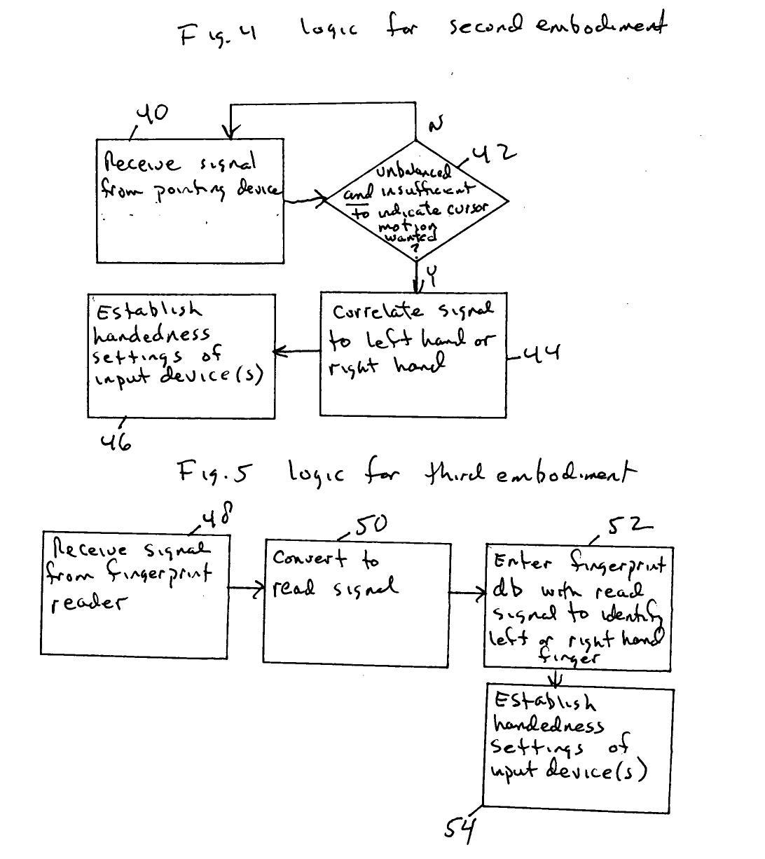

FIG. 3 shows the logic that can be used to establish handedness settings of the click elements 22, 24 based on how a user rests a finger on the touch pad 18 shown in FIG. 1. The signal from the touch pad 18 that results from finger contact is received by the processor 14 at block 32. Proceeding to block 34, the shape and/or position and/or orientation of the contour of the area touched by the finger is determined. For instance, when a user rests a finger on the touch pad 18, a roughly ovular touch area is defined that follows the contour of the finger.

Moving to block 36, the shape and/or position and/or orientation of the contour of the area touched by the finger is correlated to a left or right hand or finger. The correlation is empirically based. By way of non-limiting example, when a left-handed user rests her left index finger on the touch pad 18, an ovular touch area may be defined that has an axis which is angled generally from left to right relative to the bottom edge of the computer 12, proximal to distal. In contrast, when a right-handed user rests his right index finger on the touch pad 18, an ovular touch area may be defined that has an axis which extends from right to left relative to the bottom edge of the computer 12, proximal to distal. In such a case, the angular orientation of the axis of the touch area is correlated to left or right handedness.

Once left or right handedness has been determined at block 36, the handedness settings (functions) of the click elements 22, 24 are established at block 38. In non-limiting illustrative implementations, this can be accomplished by automatically associating, in operating system software, more common click element functions to the right click element 24 when right handedness is determined and to the left click element 22 when left handedness is determined, or vice-versa if desired.

FIG. 4 shows how signals from the movable pointing element 20 in FIG. 1 can be used to determine right or left handedness in an exemplary non-limiting embodiment. Commencing at block 40; the signals from the pressure transducer 28 shown in FIG. 2 are received. At decision diamond 42, it may be determined whether the signals represent a current imbalance but one that is of a magnitude below a threshold and/or of constant magnitude, indicating a light resting touch instead of a touch representing a desired cursor motion.

If the test at decision diamond 42 indicates a resting touch, the logic proceeds to block 44 to correlate the signal to left or right handedness. The correlation can be in accordance with empirically determined rules. By way of non-limiting example, a light touch that pushes the pointing element 20 to the right can be correlated to left-handedness, while one that pushes the pointing element 20 to the left can be correlated to right-handedness. At block 44, the handedness settings of the click elements 22, 24 are established in accordance with principles set forth above.

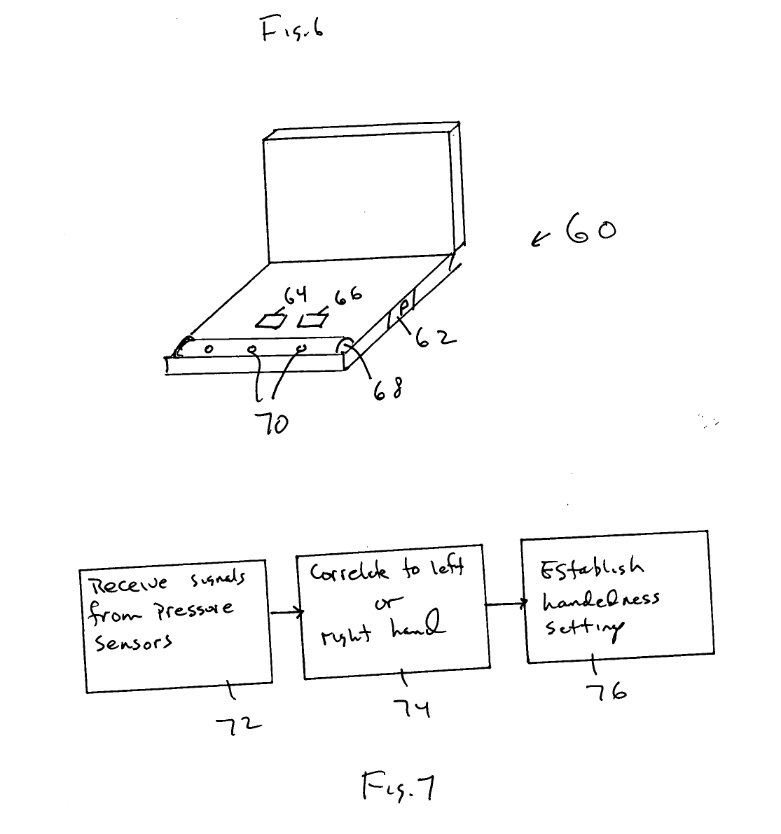

Now referring to FIG. 5, the touch pad 18 may have sufficient resolution to render it suitable as a fingerprint reader, or a separate fingerprint reader may be provided on the computer 12. In either case, at block 48 the signals from the fingerprint reader are received by the processor 14 and converted to a fingerprint read signal at block 50. Moving to block 52, a fingerprint database is entered using the read signal as entering argument to find a match of the user's fingerprint. The matching entry is correlated to a left hand finger or right hand finger, with left- or right-handedness being determined based on whether a left hand finger or right hand finger is detected. The handedness settings of the click elements 22, 24 are then established at block 54 in accordance with principles set forth above.

The finger print database that is accessed at block 52 may be contained in the computer 12. Or, it may be accessible over the Internet. In the latter case, a service can be provided wherein a user computer sends a fingerprint read signal to a Web server, which accesses the database to correlate the signal to left- or right-handedness and then return a message to the operating system of the computer 12, indicating left- or right-handedness. The message can be used by the operating system of the computer 12 to establish the handedness settings of the click elements 22, 24.

FIG. 6 shows a computer 60 having a processor 62 and click elements 64, 66 that is in all essential respects identical in configuration and operation to the computer 10 shown in FIG. 1, with the following exception. A wrist rest 68 that has a cushioned body is juxtaposed with the housing of the computer 60 and may hold plural pressure sensors 70 that send signals to the processor 62 when a user rests her hand or wrist or finger on the wrist pad 68.

FIG. 7 shows the logic used by the computer 60 shown in FIG. 6 to establish handedness settings. Commencing at block the signals are received, and at block 74 the signals are correlated to a left hand or right hand. The correlation may be based on empirically determined rules. By way of non-limiting example, when left-most sensors indicate greater force than right-most sensors, this circumstance can be correlated to left handedness and vice-versa. Or, when upper (relative to the computer 60) sensors indicate greater force than lower sensors, this circumstance can be correlated to left handedness and vice-versa. It is to be understood that these exemplary rules are illustrative only and non-limiting. At block 76, the functions (handedness) of the click elements 64, 66 are established by the processor 62 as appropriate based on the determination made at block 74.

If desired, the above-described automatic establishment of click element functions (i.e., of handedness) can be selectively enabled by the user. If desired, the determinations regarding handedness set forth above can be made, but the handedness settings changed from default values or current values only upon prompting the user that a change is about to occur and receiving a confirmation signal from the user to change the settings. If further desired, the handedness settings may be automatically changed only upon user logon or elapse of a predetermined time period, e.g., only if pressure signals from the above-described sensors indicate that the user has rested his or her hand on the surface associated with the sensors (e.g., on the housing 22) longer than a threshold period.

While the particular SYSTEM AND METHOD FOR AUTOMATICALLY ESTABLISHING HANDEDNESS SETTINGS OF EMBEDDED INPUT DEVICE as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art; and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for” or, in the case of a method claim, the element is recited as a “step” instead of an “act”. Absent express definitions herein, claim terms are to be given all ordinary and accustomed meanings that are not irreconcilable with the present specification and file history.

What is claimed is:

1. A method comprising:
receiving at least one signal from at least one input device on a computer, the input device having at least one function other than establishing handedness settings, the signal being generated when a user makes resting tactile contact with the input device; and
based at least in part on the signal, automatically establishing at least one handedness setting.

2. The method of claim 1, wherein the input device includes a touch pad and at least two buttons, and the handedness settings are established for the buttons based on a signal that is generated when a user makes resting tactile contact with the touch pad.

3. The method of claim 2, wherein a touch region is defined when the user makes resting tactile contact with the touch pad, and the signal represents at least one of: a shape, a location, and an orientation, of the touch region.

4. The method of claim 1, wherein the input device includes a pointing element mounted on a keyboard region of the computer and at least two buttons, and the handedness settings are established for the buttons based on a signal that is generated when a user makes resting tactile contact with the pointing element.

5. The method of claim 4, wherein the pointing element is one of: a joystick, and a trackpoint element.

6. The method of claim 4, wherein the pointing element is associated with a pressure transducer, and resting tactile contact with the pointing element causes a current imbalance in the pressure transducer, the signal that is generated when a user makes resting tactile contact with the pointing element being representative of the current imbalance.

7. The method of claim 1, wherein the input device includes at least one fingerprint reader, the computer correlating a fingerprint image from the reader to a left finger or right finger to establish the handedness setting.

8. A computer system, comprising:
a computer housing holding at least one processor;
at least one pointing element on the computer housing; and
at least two click elements on the computer housing, wherein
the processor automatically establishes at least one function for at least one of the click elements based on at least one signal from the pointing element.

9. The system of claim 8, wherein the pointing element includes a touch pad, and functions are established for the click elements based on a signal that is generated when a user makes tactile contact with the touch pad.

10. The system of claim 9, wherein a touch region is defined when the user makes resting tactile contact with the touch pad, and the signal represents at least one of: a shape, a location, and an orientation, of the touch region.

11. The system of claim 8, wherein the pointing element includes a movable pointing element and functions are established for the click elements based on a signal that is generated when a user makes resting tactile contact with the movable pointing element.

12. The system of claim 11, wherein the movable pointing element is one of: a joystick, and a trackpoint element.

13. The system of claim 11, wherein the movable pointing element is associated with a pressure transducer, and resting tactile contact with the movable pointing element causes a current imbalance in the pressure transducer, a signal that is generated when a user makes resting tactile contact with the movable pointing element being representative of the current imbalance.

14. A computer including at least one fingerprint reader, the computer correlating a fingerprint image from the reader to a left finger or right finger to establish at least one handedness setting for at least one input device.

15. The computer of claim 14, wherein the computer accesses a fingerprint database located in the computer or on the Internet.

16. The computer of claim 15, wherein functions are automatically established for at least two click elements.

17. A service, comprising:
receiving a fingerprint signal from at least one user computer; and
returning to the user computer a signal representing “left” or “right” to facilitate establishing handedness settings for click elements associated with the computer.

18. A computer program device executable by a computer holding at least one processor, at least one means for pointing, and at least two means for clicking on the computer housing, the program device embodying means for automatically establishing at least one handedness setting based at least in part on a signal that is generated when a user makes resting tactile contact with the means for pointing.

19. The computer program device of claim 18, wherein the means for pointing includes a touch pad and the means for clicking includes at least two buttons, and the handedness settings are established for the buttons based on a signal that is generated when a user makes resting tactile contact with the touch pad.

20. The computer program device of claim 19, wherein a touch region is defined when the user makes resting tactile contact with the touch pad, and the signal represents at least one of: a shape, a location, and an orientation, of the touch region.

21. The computer program device of claim 18, wherein the means for pointing includes a pointing element mounted on a keyboard region of the computer and the means for clicking includes at least two buttons, and the handedness settings are established for the buttons based on a signal that is generated when a user makes resting tactile contact with the pointing element.

22. The computer program device of claim 21, wherein the pointing element is one of: a joystick, and a trackpoint element.

23. The computer program device of claim 21, wherein the pointing element is associated with a pressure transducer, and resting tactile contact with the pointing element causes a current imbalance in the pressure transducer, the signal that is generated when a user makes resting tactile contact with the pointing element being representative of the current imbalance.

24. A computer system, comprising:
a processor supported by a computer housing;
a wrist rest juxtaposed with the housing; and
plural pressure sensors disposed in the body and outputting signals representative of a user resting a portion of the user's body on the wrist rest, the signals being useful by the processor in determining handedness.

25. The system of claim 24, wherein the processor receives the signals and establishes functions of at least two click elements in response thereto, wherein the click elements are on the housing of the computer.
